(19) United States
(12) Patent Application Publication
(10) Pub. No.: US 2006/0090627 A1
(43) Pub. Date: May 4, 2006

(54) Adjustable mute device

(76) Inventor: Sharay Dion Reed, Dolton, IL (US)

Correspondence Address: Sharay Reed, 14511 South Kenwood Avenue, Dolton, IL, 60419, US

(21) Appl. No.: 10/978,095

(22) Filed: Nov. 1, 2004

(51) Int. Cl. G10D 3/00

(52) U.S. Cl. 84/319

(57) ABSTRACT

A mute device for a stringed instrument is readily attached to the strings of the instrument. The mute can be adjusted longitudinally along the strings while playing the instrument, for achieving a variably muted sound. The invention is preferably used in combination with an electric bass guitar, and is manipulated along the strings near the bridge to acquire a particular muted sound for a note.

### BACKGROUND OF THE INVENTION

1. Field of the Invention

This invention relates to a mute or damper device for stringed musical instruments, and more particularly relates to a mute device that engages to an electric bass guitar to diminish the sound and vibration of the strings. The mute is adjustable between the bridge and the anchoring region of the strings for muting the strings while playing the guitar.

2. Description of the Related Art

Muting and damper devices for stringed instruments are directed to reducing sound levels by attaching to the strings to the guitar. Muting devices acting simultaneously on all strings are typically located next to the bridge. Such devices have been utilized on both acoustic and hard body electric guitars to lower the sound. This is one of very the few ways available to lower the loudness and modify the tone for a guitar. Often, a musician will use the ball or other region of a hand to contact the strings, in order to mute the sound.

Typical muting devices are mounted to the guitar on a lever arm. The mute device is readily engaged to the strings by a performing musician by moving the lever arm to contact the device to the strings. This type of mute requires the modification of the guitar, in order to mount the mute device to the guitar. Often, this type of mute proves cumbersome to a performing musician, who may often be very mobile and animated as part of an overall performance. Additionally, songs requiring the limited muting of particular notes at certain notes in the song make it unnecessarily burdensome to mount a mute to the guitar.

There is a need to for a mute device a practical, mobile, and durable mute for an electric bass guitar that provides degrees of damping effect. The present invention proposes to solve the problems of the musician having to use the ball of his hand to mute the notes during play, and of having to mount the mute to the instrument.

### BRIEF SUMMARY OF THE INVENTION

The present invention provides a damper device for a stringed instrument, by restricting sound from unplayed open and closed strings, and played open and closed strings. The invention adjustably and securely engages to the strings of the instrument, thereby enabling movement along the strings to obtain a variety of muted sounds when the guitar is played without a threat of being inadvertently dropped from the instrument. The present invention is directed to all strings, or as many particular strings as desired by the player.

### BRIEF DESCRIPTION OF THE SEVERAL VIEWS OF THE DRAWINGS

FIG. 1 is a view illustrating the mute bar utilized in the present invention.

FIG. 2 is a side view illustrating a series of retaining recesses.

FIG. 3 is a side view illustrating the preferred embodiment of the present invention.

FIG. 4 is a view in perspective illustrating the preferred embodiment engaged to a series of strings on an electric bass guitar.

### DETAILED DESCRIPTION OF THE INVENTION

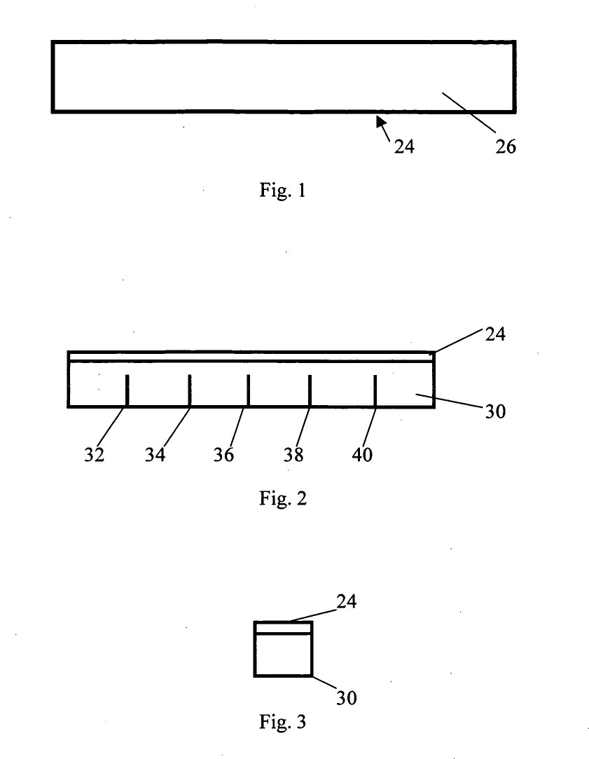

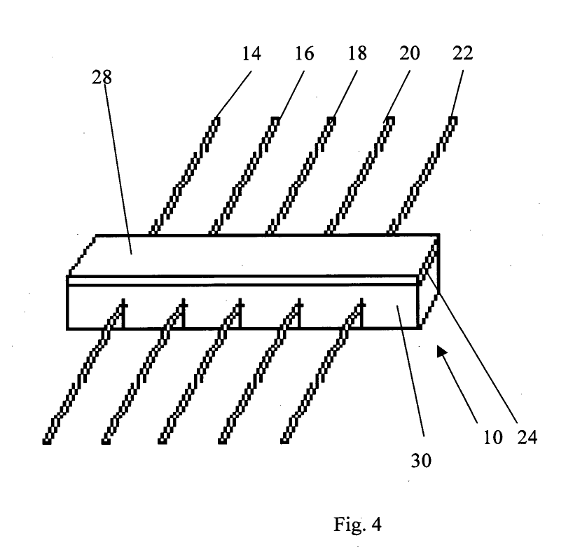

FIG. 1 shows a mute bar 24 configured generally as a rectangular strip of hard material. One of a pair of opposing broad surfaces 26 and 28 (see FIG. 4) is shown. The mute 24 bar is generally considerably longer than it is wide. The length of the mute bar 24 is preferably 3 and ¾ inches, the width is ½ inch, and the mute bar 24 has a thickness of ⅛ inch. The mute bar 24 can be composed of plastic, metal, steel, or other similarly rigid material, but preferably is made of aluminum.

FIG. 2 is a side view of the mute 10 (shown in FIG. 4). A muting material 30 is bonded to the mute bar 24 by any usual means such as gluing. However, the muting material 30 may be connected to the mute bar 24 by any satisfactory means. The muting material 30 has a plurality of slotted recess portions 32, 34, 36, 38, and 40. The muting material 30 needs to be about ½ of an inch thick, and is preferably composed of foam rubber. FIG. 3 is another side view of the mute 10. As shown in FIGS. 2 and 3 the muting material 30 extends to each edge of the mute bar 24. The preferred width of the mute 10 is about ½ of an inch. The mute 10 has a total height, or thickness, of about ⅝ of an inch.

The mute 10 is directed to use on stringed instruments, preferably an electric bass guitar (not shown). FIG. 4 illustrates the basic structure of the instrument, which has a set of tensioned strings 14, 16, 18, 20, and 22 disposed in proximity to a surface of the guitar. The strings 14, 16, 18, 20, and 22 are supported at a predetermined separation above the surface.

In FIG. 4, the preferred embodiment of the mute 10 is shown attached to a set of strings 14, 16, 18, 20, and 22 on a guitar (not shown). The plurality of slotted recess portions 32, 34, 36, 38, and 40 are shown engaged to the strings 14, 16, 18, 20, and 22 of the guitar. The mute 10 is thereby slidingly engaged to the guitar. Typically, a bass guitar has five strings, although there are other versions having more strings, and it is contemplated that larger versions of the present invention may be built to use for those guitars having other amounts of strings and arrangements for strings. Additionally, the mute 10 may be engaged to less than the full number of strings on a stringed instrument, in order to selectively mute a note or string, while leaving at least one other string to vibrate unhindered by the mute 10.

Adjustably engaging the strings 14, 16, 18, 20, and 22 means that the mute 10 may be manually adjusted in order to achieve a selectively variable muting level of sound. The sound may be altered to different muting levels while playing all strings or a particular note by sliding the mute 10 along the strings 14, 16, 18, 20, and 22. The plurality of slotted recess portions 32, 34, 36, 38, and 40 are configured to cover particular linear portions of the strings 14, 16, 18, 20, and 22. The muting material 30 contacts and constrains the overall amplitude and vibration of the strings 14, 16, 18, 20, and 22, resulting in the sound damping effect.

To provide an optimum performance for adjustably muting the sound levels of an electric bass guitar, the mute device 10 is preferably utilized at a region of the bridge of the guitar. The bridge is an operative part of the strings 14, 16, 18, 20, and 22 that may be manipulated by a musician desiring a particular sound for a note. The mute device 10 is readily removed for playing the guitar in a conventional mode.

1. A mute for a stringed instrument, said mute comprising:
a mute bar configured generally as a rectangular strip of hard material having a pair of opposing broad surfaces,
muting material bonded to a surface of said mute bar, said muting material having a plurality of slotted recess portions for slidingly engaging to said strings,
whereby a selectively variable muting level may be effected by sliding said mute longitudinally along said strings while playing said instrument.

2. The mute of claim 1, wherein said muting material is a block of foam rubber.

3. The mute of claim 1, wherein said mute bar is plastic.

4. The mute of claim 1, wherein said mute bar is a metal.

5. The mute of claim 4, wherein said metal is aluminum or steel.

6. The mute of claim 1, wherein said muting material has a thickness of about 12 inch.

7. The mute of claim 7, wherein said mute bar has a thickness of about ⅛ inch.
